(19) United States
(12) Patent Application Publication
(10) Pub. No.: US 2022/0186451 A1
(43) Pub. Date: Jun. 16, 2022

(54) REMOTE SENSING-BASED DYNAMIC ESTIMATION METHOD FOR OUTFLOW PROCESS OF UNGAUGED FREE OVERFLOW RESERVOIR

(71) Applicant: HOHAI UNIVERSITY, Nanjing (CN)

(72) Inventors: Ke ZHANG, Nanjing (CN); Nan WU, Nanjing (CN); Linxin LIU, Nanjing (CN)

(21) Appl. No.: 17/551,211

(22) Filed: Dec. 15, 2021

(30) Foreign Application Priority Data
Dec. 16, 2020 (CN) 202011484971.X
Dec. 30, 2020 (CN) 202011606488.4

(51) Int. Cl. E02B 7/20; E02B 8/06; G08B 21/10

(52) U.S. Cl. CPC E02B 7/205; G08B 21/10; E02B 8/06

(57) ABSTRACT

A remote sensing-based dynamic estimation method for the outflow process of an ungauged free overflow reservoir comprising the following steps: estimating the storage volumes of the water reservoir at different water levels from the water level-area relation curve of the water reservoir by using a digital elevation model, and thereby establishing an area-storage volume relation curve of the water reservoir; obtaining the storage volumes of the water reservoir at the corresponding times; obtaining the change of the storage volume of the water reservoir through accumulative calculation on the change of the storage volume in the time periods corresponding to the two remote sensing images; gradually approximating an outflow coefficient of the water reservoir by using a bisection method; taking the final approximation result as the outflow coefficient of the ungauged reservoir, and calculating the outflow process of the water reservoir during floods.

### TECHNICAL FIELD

The present invention relates to the technical field of water conservancy projects, particularly to a remote sensing-based dynamic estimation method for the outflow process of an ungauged free overflow reservoir, which is mainly used for flood forecasting, risk assessment and early warning in regions where the influence of water conservancy projects is great but no survey data is available.

### BACKGROUND ART

In recent few decades, with the population growth and the development of the social economy, the water problem has become one of the increasingly serious problems in the world. The spatiotemporal distribution of water resources has been greatly changed by human activities. In order to alleviate the contradiction between flood control and beneficial use of the water resources, a large number of water conservancy projects have been built in drainage basins, and water reservoir projects are the most common among the water conservancy projects. Some small or medium-sized water reservoirs have been constructed by the local residents spontaneously, owing to the advantages of such water reservoirs, including low engineering workload and easy operation and management, etc. However, hydrological analysis and calculation were not carried out for those water reservoirs in the early stage of construction, and corresponding construction data was not available. Most small or medium-sized water reservoirs employed earth-filled dams and had no gate control. Consequently, the original landforms of the drainage basins have been changed to a great extent. At present, it is difficult to monitor the regulation processes of all water reservoirs in real time. Therefore, the actual discharge processes of the water reservoir groups are usually unknown.

Flood forecasting plays a particularly important role on flood control, drought defying and rational utilization of water resources. For numerous small and medium-sized water reservoirs that are widely distributed, it is difficult to fully gain their operational data. If there is no rain for a long time in the early stage, most of the surface runoff will be impounded by the water reservoirs after rainfalls, resulting in an actual flood volume lower than the forecast value; if the rainfalls are plenty in the early stage, outflow or even dam failure may occur at some small or medium-sized water reservoirs in the drainage basin upon a heavy rainfall event, resulting in a forecast value severely lower than the actual volume. Therefore, it is highly necessary to take consideration of the influence of human activities, such as impoundment or flood discharge at small and medium-sized water reservoirs, in flood forecasting.

In the consideration of the influence of water reservoirs, the calculation method is usually simplified appropriately because it is generally believed that small and medium-water reservoirs are different from large-sized ones only in terms of the scale. However, such a handling method often leads to severe errors in the calculation results. Therefore, a new technical solution is needed to make compensation for the unavailability of engineering data of small and medium-sized water reservoirs and take consideration of the influence of those water reservoirs on runoff yield and confluence in flood forecasting.

### SUMMARY OF THE INVENTION

The technical problem to be solved by the present invention is to provide a remote sensing-based dynamic estimation method for the outflow process of an ungauged free overflow reservoir, which can approximate the actual outflow coefficient of the water reservoir.

In order to attain the above objective, the present invention employs the following technical solution:

A remote sensing-based dynamic estimation method for the outflow process of an ungauged free overflow reservoir, wherein the flood releasing buildings of the free overflow reservoir employ overflow weirs without gate control, and there is no characteristic water level, storage volume curve and drainage curve of the free overflow reservoir, the method comprises the following steps:

Step 1. Obtaining a water level-area relation curve of the water reservoir based on the digital elevation model (DEM) data; estimating the storage volumes of the water reservoir at different water levels from the water level-area relation curve of the reservoir, and establishing an area-storage volume relation curve of the water reservoir;

Step 2. Extracting the water surface area of the ungauged reservoir from remote sensing images, and obtaining the storage volumes of the water reservoir in the time periods corresponding to the remote sensing images using the water surface area data and the water level-area-storage volume relation curves in combination;

Step 3. Obtaining the change of the storage volume of the water reservoir through the cumulative calculations on the storage volume changes in the time periods corresponding to the two remote sensing images with a hydraulic outflow calculation formula under a principle of water balance;

Step 4. Gradually approximating an outflow coefficient of the water reservoir by using a bisection method, so that the change of the storage volume of the reservoir obtained through the calculation under the principle of water balance is consistent with the change of the storage volume in the time periods corresponding to the two remote sensing images;

Step 5. Taking the final approximation result as the outflow coefficient of the ungauged reservoir, and calculating the outflow process of the water reservoir during floods.

The step 1 comprises:

Step 11. Extracting the water surface area of the ungauged reservoir at different contour lines by using the digital elevation model to obtain the water level-area relation curve of the water reservoir;

Step 12. Dividing the water reservoir into layers by elevation difference Δh (taking the value within 1.5 m), starting from the bottom of the water reservoir, according to the water level-area relation curve of the water reservoir, and calculating the storage volumes of the water reservoir at different water levels with the following formula:

$$V ( {h}_{l} ) = {\sum }_{j = 1}^{l} Δ V ( {h}_{j} )$$

$${h}_{j} = j \times Δ h$$

$$Δ V ( {h}_{j} ) = \frac{Δ h}{3} ( S ( {h}_{j - 1} ) + \sqrt{S ( {h}_{j - 1} ) \times S ( {h}_{j} )} + S ( {h}_{j} ) )$$

where hₗ represents the water level of the l^{th} layer; V(hₗ) represents the total storage volume of the water reservoir corresponding to the water level hₗ; ΔV(hⱼ) represents the incremental storage volume from the j−1^{th} layer to the j^{th} layer; S(hⱼ₋₁) and S(hⱼ) represent the water surface areas of the water reservoir at the (j−1)^{th} layer and j^{th} layer;

Step 13. Obtaining an area-storage volume relation curve of the water reservoir by using the storage volume data at different water levels obtained with the above formula and the water level-area relation curve in combination.

The step 3 comprises:

Obtaining two remote sensing images at different times at a time interval ΔT after flood releasing of the reservoir is started, taking Δt starting from the first remote sensing image as a unit calculation period, calculating a cumulative sum of the storage volume in k unit calculation periods, and adding the calculated cumulative sum to the initial storage volume of the water reservoir to obtain the corresponding storage volume of the water reservoir after a time period k×Δt:

$${t}_{k} = {t}_{0} + k \times Δ t$$

$$V ( {t}_{k} ) = {V}_{0} + {\sum }_{i = 1}^{k} Δ V ( Δ {t}_{i} )$$

where t₀ represents the time corresponding to the first remote sensing image, i.e., the initial time; V(tₖ) represents the corresponding storage volume of the reservoir after the period k×Δt from the initial time; V₀ represents the corresponding storage volume of the water reservoir at the initial time, i.e., the initial storage volume; ΔV(Δtᵢ) represents the change of the storage volume of the water reservoir corresponding to the i^{th} unit calculation period; Δtᵢ represents the i^{th} unit calculation period:

Obtaining a storage volume sequence V(t₁), V(t₂), . . . , V(tₖ) of the water reservoir through the cumulative calculation in k×Δt time periods, and then obtaining a water level sequences H(t₁), H(t₂), . . . , H(tₖ) of the water reservoir by using the storage volume sequence and the water level-area-storage volume curves obtained in the step 2 in combination;

Carrying out cumulative calculation in time period ΔT when

$$k = \frac{Δ T}{Δ t} ,$$

to obtain the storage volume of the water reservoir corresponding to the second remote sensing image; here, the change of the storage volume of the water reservoir in the time period corresponding to the two remote sensing images is as follows:

$$\overline{Δ V} = {\sum }_{i = 1}^{k} Δ V ( Δ {t}_{i} )$$

where Δ̅V̅ represents the change of the storage volume of the water reservoir in the time period ΔT corresponding to the two remote sensing images.

In the step 3, the corresponding change ΔV(Δtᵢ) of the storage volume of the water reservoir during the i^{th} segment of the time period ΔT is calculated with a water balance equation as follows:

ΔV(Δtᵢ)=Wᵢₙ(Δtᵢ)+Wₚ(Δtᵢ)−Wₒᵤₜ(Δtᵢ)

where Wᵢₙ(Δtᵢ) represents the total volume of inflow from the upstream of the reservoir within Δtᵢ; Wₚ(Δtᵢ) represents the total volume of rainfall on the water surface area of the water reservoir within Δtᵢ; Wₒᵤₜ(Δtᵢ) represents the total volume of outflow through the spillway within Δtᵢ;

Wᵢₙ(Δtᵢ)=QᵢₙΔΔtᵢ

Wₚ(Δtᵢ)=Qₚ×Δtᵢ

Wₒᵤₜ(Δtᵢ)=Qₒᵤₜ×Δtᵢ

where Qᵢₙ represents the inflow from the upstream of the reservoir within Δtᵢ; Qₚ represents the flow formed by rainfall on the water surface area of the water reservoir within Δtᵢ; Qₒᵤₜ represents the flow discharged through the spillway of the reservoir within Δtᵢ:

Wherein, the flow Qₒᵤₜ discharged through the spillway is calculated with a weir flow formula:

$${Q}_{out} = {λ}_{0} \times {( H ( {t}_{i} ) - {H}_{c} )}^{\frac{3}{2}}$$

where Qₒᵤₜ is the flow of discharge through the spillway at water level H(tᵢ), H_{c} is the crest elevation of the weir, and λ₀ is an outflow coefficient.

In the step 4, a function solved with the bisection method is as follows:

ƒ(λ)=ΔV*−Δ̅V̅(λ)

where ΔV* represents an ideal value of the change of the storage volume of the water reservoir corresponding to the two remote sensing images, which is obtained in step 2;

The steps of solving an approximate value of the function ƒ(λ) at the zero point under a given accuracy with the bisection method are as follows:

Step 41. Determining an interval [a, b], verifying ƒ(a)×ƒ(b)<0, and specifying an accuracy ζ;

Step 42. Finding the midpoint c of the interval (a, b);

Step 43. Calculating ƒ(c):

(1) if ƒ(c)=0, then c is the zero point of the function,

(2) if ƒ(a)×ƒ(c)<0, then b=c,

(3) if ƒ(c)×ƒ(b)<0, then a=c,

(4) Determining whether the accuracy ζ is reached, i.e., if |a−b|<ζ, then an approximate value a (or b) at the zero point is obtained; otherwise, the steps 42-43 are repeated.

Beneficial effects: the present invention provides a remote sensing-based dynamic estimation method for the outflow process of an ungauged free overflow reservoir, in which a water level-area-storage volume relation curve of the water reservoir is established by using a digital elevation model and mathematical formulae in combination, the water surface area of the ungauged reservoir is derived from high-resolution remote sensing images, and thereby the storage volumes of the water reservoir at the corresponding times are obtained first; then, the change of the storage volume of the water reservoir is obtained through cumulative calculation on the change of the storage volume in the time periods corresponding to two remote sensing images with a hydraulic outflow calculation formula under the principle of water balance; the change of the storage volume of the water reservoir obtained from the remote sensing images is taken as an ideal value, and an outflow coefficient of the water reservoir is approximated gradually with a bisection method, so that the change of the storage volume of the water reservoir calculated under the principle of water balance is consistent with the change of the storage volume in the period corresponding to the two remote sensing images; finally, the final approximation result is taken as the outflow coefficient of the ungauged reservoir, and the outflow process of the water reservoir during floods is calculated. The method provided by the present invention gradually approximates the outflow coefficient of an ungauged free overflow reservoir in a mathematical approach on the basis of remote sensing images. It makes compensation for the unavailability of characteristic data and outflow process of free overflow reservoirs without data, so that the influence of runoff yield and confluence of the water reservoirs can be taken into account in flood forecasting, thereby the accuracy of flood forecasting in the regions of water reservoirs can be improved effectively.

### BRIEF DESCRIPTION OF THE DRAWINGS

FIG. 1 is a schematic flow chart of obtaining the outflow coefficient of an ungauged free overflow reservoir by using a bisection method in the present invention:

FIG. 2 shows a water level-area relation curve of the Dongfanghong Reservoir in the drainage basin in an embodiment of the present invention;

FIG. 3 shows an area-storage volume relation curve of the Dongfanghong Reservoir in the drainage basin in the embodiment;

FIG. 4 shows two historical remote sensing images of 20150608 and 20150614 corresponding to floods in the embodiment;

FIG. 5 shows relation curves of the variations of error and outflow coefficient with the increase of the number of iterations in the embodiment;

FIG. 6 shows a schematic view of an outflow process of the reservoir during floods in the embodiment.

### EMBODIMENTS

Hereunder the present invention will be further detailed in specific embodiments, with reference to the accompanying drawings.

It should be understood that the embodiments described hereunder are only provided to interpret the present invention but don't constitute any limitation to the present invention.

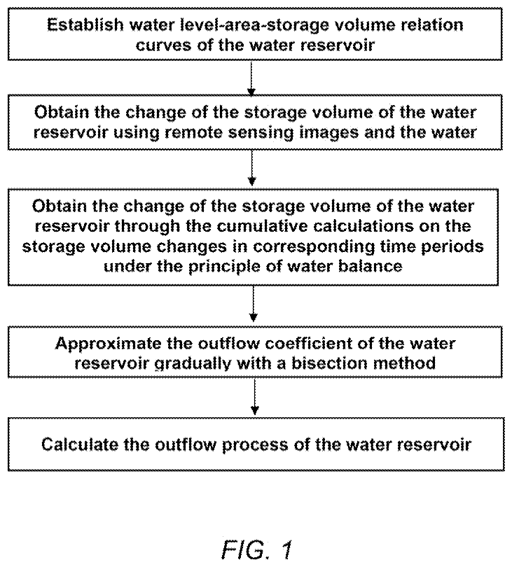

As shown in FIG. 1, taking Dongfanghong Reservoir as an example, the remote sensing-based dynamic estimation method for the outflow process of an ungauged free overflow reservoir in the present invention comprises the following steps:

Step 1. Obtaining a water level-area relation curve of the water reservoir based on the digital elevation model (DEM) data, estimating the storage volumes of the water reservoir at different water levels with mathematical formulae, and thereby establishing an area-storage volume relation curve of Dongfanghong Reservoir:

The step 1 comprises:

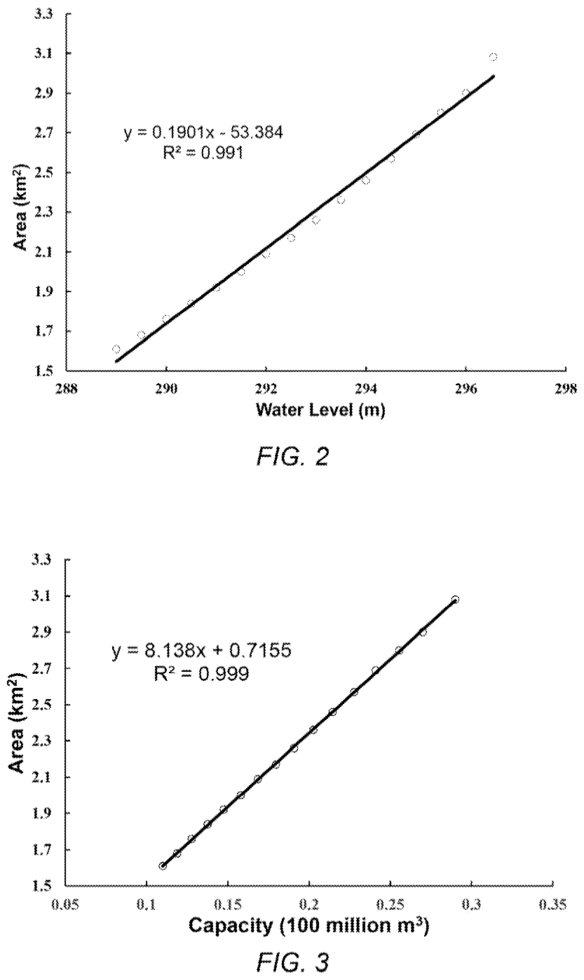

Step 11. Extracting the water surface areas of the ungauged reservoir at different contour lines by using the digital elevation model, and obtaining a water level-area relation curve of Dongfanghong Reservoir in Tunxi Drainage Basin, as shown in FIG. 2;

Step 12. Dividing the water reservoir into layers by an elevation difference Δh that is small enough, starting from the bottom of the water reservoir, according to the water level-area relation curve of the water reservoir, and calculating the storage volumes of the water reservoir at different water levels with the following formula:

$$\begin{matrix}V ( {h}_{l} ) = {\sum }_{j = 1}^{l} Δ V ( {h}_{j} ) & ( 1 ) \\ {h}_{j} = j \times Δ h & ( 2 ) \\ Δ V ( {h}_{j} ) = \frac{Δ h}{3} ( S ( {h}_{j - 1} ) + \sqrt{S ( {h}_{j - 1} ) \times S ( {h}_{j} )} + S ( {h}_{j} ) ) & ( 3 )\end{matrix}$$

where hₗ represents the water level of the l^{th} layer; V(hₗ) represents the total storage volume of the water reservoir corresponding to the water level hₗ; ΔV(hⱼ) represents the incremental storage volume from the j−1^{th} layer to the j^{th} layer; S(hⱼ₋₁) and S(hⱼ) represent the water surface areas of the water reservoir at the (j−1)^{th} layer and the j^{th} layer;

Step 13. Obtaining an area-storage volume relation curve of Dongfanghong Reservoir by using the storage volume data at different water levels obtained with the above formula and the water level-area relation curve in combination, as shown in FIG. 3;

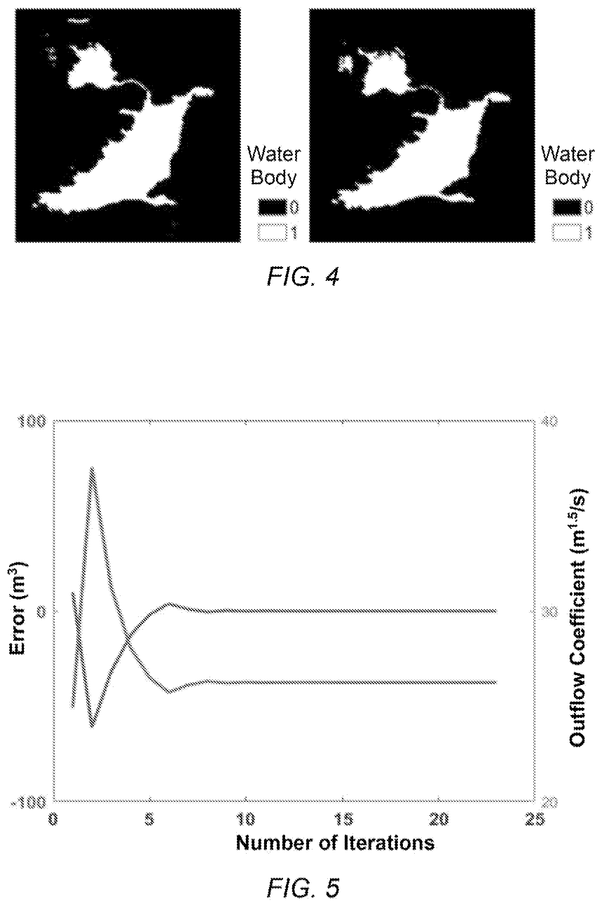

Step 2. Extracting the water surface areas of Dongfanghong Reservoir from high-resolution remote sensing images, selecting two historical remote sensing images of 20150608 and 20150614 corresponding to floods, as shown in FIG. 4, and obtaining the storage volumes of the reservoir at the corresponding times by using the water surface area data and the area-storage volume relation curve in combination;

Step 3. Obtaining the change of the storage volume of the water reservoir through the cumulative calculations on the change of storage volume in the time periods corresponding to the two remote sensing images with a hydraulic outflow calculation formula under a principle of water balance;

Obtaining two remote sensing images at different times at a time interval ΔT after flood releasing is started from the reservoir, taking Δt starting from the first remote sensing image as a unit calculation period, calculating a cumulative sum of the storage volume in k unit calculation periods, and adding the calculated cumulative sum to the initial storage volume of the water reservoir to obtain the corresponding storage volume of the water reservoir after a time period k×Δt:

$$\begin{matrix}{t}_{k} = {t}_{0} + k \times Δ t & ( 4 ) \\ V ( {t}_{k} ) = {V}_{0} + {\sum }_{i = 1}^{k} Δ V ( Δ {t}_{i} ) & ( 5 )\end{matrix}$$

where t₀ represents the time corresponding to the first remote sensing image, i.e., the initial time; V(tₖ) represents the corresponding storage volume of the reservoir after the period k×Δt from the initial time; V₀ represents the corresponding storage volume of the water reservoir at the initial time, i.e., the initial storage volume; ΔV(Δtᵢ) represents the change of the storage volume of the water reservoir corresponding to the unit calculation period i; Δtᵢ represents the i^{th} unit calculation period;

Obtaining a storage volume sequence V(t₁), V(t₂), . . . , V(tₖ) of the water reservoir through the cumulative calculation in k×Δt time periods, and then obtaining a water level sequences H(t₁), H(t₂), . . . , H(tₖ) of the water reservoir by using the storage volume sequence and the water level-area-storage volume relation curves obtained in the step 2 in combination;

Carrying out cumulative calculation in time period ΔT when

$$k = \frac{Δ T}{Δ t} ,$$

to obtain the storage volume of the water reservoir corresponding to the second remote sensing image; here, the change of the storage volume of the water reservoir in the time period corresponding to the two remote sensing images is as follows:

$$\overline{Δ V} = {\sum }_{i = 1}^{k} Δ V ( Δ {t}_{i} ) \qquad ( 6 )$$

where ΔV represents the change of the storage volume of the water reservoir in the time period ΔT corresponding to the two remote sensing images;

The corresponding change ΔV(Δtᵢ) of the storage volume of the water reservoir during the i^{th} segment of the time period ΔT is calculated with a water balance equation as follows:

ΔV(Δtᵢ)=Wᵢₙ(Δtᵢ)+Wₚ(Δtᵢ)−Wₒᵤₜ(Δtᵢ) (7)

where Wᵢₙ(Δtᵢ) represents the total volume of inflow from the upstream of the reservoir within Δtᵢ; Wₚ(Δtᵢ) represents the total volume of rainfall on the water surface area of the water reservoir within Δtᵢ; Wₒᵤₜ(Δtᵢ) represents the total volume of outflow through the spillway within Δtᵢ;

Wᵢₙ(Δtᵢ)=Qᵢₙ×Δtᵢ (8)

Wₚ(Δtᵢ)=Qₚ×Δtᵢ (9)

Wₒᵤₜ(Δtᵢ)=Qₒᵤₜ×Δtᵢ (10)

where Qᵢₙ represents the inflow from the upstream of the reservoir within Δtᵢ; Qₚ represents the flow formed by rainfall on the water surface area of the water reservoir within Δtᵢ; Qₒᵤₜ represents the flow discharged through the spillway of the reservoir within Δtᵢ;

Wherein, the flow Qₒᵤₜ discharged through the spillway may be calculated with a weir flow formula:

$${Q}_{out} = {λ}_{0} \times {( H ( {t}_{i} ) - {H}_{c} )}^{\frac{3}{2}} \qquad ( 11 )$$

where Qₒᵤₜ is the flow discharged through the spillway at water level H(tᵢ), H_{c} is the crest elevation of the weir, and λ₀ is an outflow coefficient, which depends on the specific type and design size of the overflow weir;

Obtaining an outflow sequence Qₒᵤₜ(t₁), Qₒᵤₜ(t₂), . . . , Qₒᵤₜ(tₖ) of the water reservoir by substituting a water level sequence H(t₁), H(t₂), . . . , H(tₖ) of the water reservoir into the above weir flow formula;

Step 4. Gradually approximating an outflow coefficient of the water reservoir by using a bisection method, so that the change of the storage volume of the reservoir obtained through the calculation under the principle of water balance is consistent with the change of the storage volume in the time periods corresponding to the two remote sensing images;

The function solved with the bisection method is as follows:

ƒ(λ)=ΔV*−Δ̅V̅(λ) (12)

where ΔV* represents an ideal value of the change of the storage volume of the water reservoir corresponding to the two remote sensing images, which is obtained in step 2;

The steps of solving an approximate value of the function ƒ(λ) at the zero point under a given accuracy with the bisection method are as follows:

Step 41. Determining an interval [a, b], verifying ƒ(a)×ƒ(b)<0, and specifying an accuracy ζ;

Step 42. Finding the midpoint c of the interval (a, b);

Step 43. Calculating ƒ(c):

(1) if ƒ(c)=0, then c is the zero point of the function,

(2) if ƒ(a)×ƒ(c)<0, then b=c,

(3) if ƒ(c)×ƒ(b)<0, then a=c,

(4) Determining whether the accuracy ζ is reached, i.e., if |a−b|≤ζ, then an approximate value a (or b) at the zero point is obtained; otherwise, the step 42 to the step 43 are repeated;

The accuracy can be reached finally after 23 iterations; the curves of the variations of error and outflow coefficient with the increase of the number of iterations are shown in FIG. 5;

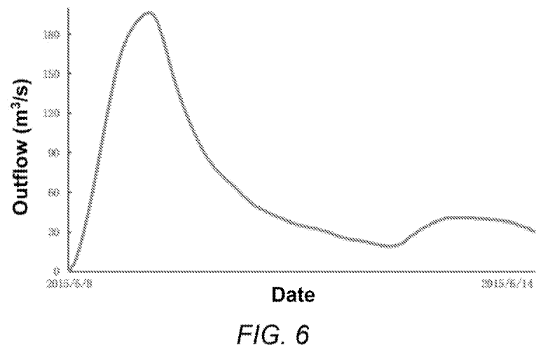

Step 5. Taking the final result of the iterations as the outflow coefficient of the ungauged reservoir, and calculating the outflow process of the water reservoir during floods, as shown in FIG. 6.

The embodiments described above are only preferred embodiments of the present invention, which are not used to limit the present invention. Numerous improvements and optimizations may be made by those skilled in the art without departing from the concept of the present invention, but such improvements and optimizations should be deemed as falling into the scope of protection of the present invention.

1. A remote sensing-based dynamic estimation method for the outflow process of an ungauged free overflow reservoir, wherein the flood releasing buildings of the free overflow reservoir employ overflow weirs without gate control, and there is no characteristic water level, storage volume curve and drainage curve of the free overflow reservoir, the method comprises the following steps:
Step 1: Obtaining a water level-area relation curve of the water reservoir based on the digital elevation model (DEM) data; estimating the storage volumes of the water reservoir at different water levels from the water level-area relation curve of the reservoir, and establishing an area-storage volume relation curve of the water reservoir;
Step 2: Extracting the water surface area of the ungauged reservoir from remote sensing images, and obtaining the storage volumes of the water reservoir in the time periods corresponding to the remote sensing images by using the water surface area data and the water level-area-storage volume relation curve in combination;
Step 3: Obtaining the change of the storage volume of the water reservoir through the cumulative calculations on the storage volume changes in the time periods corresponding to the two remote sensing images with a hydraulic outflow calculation formula under a principle of water balance;
Step 4: Gradually approximating an outflow coefficient of the water reservoir by using a bisection method, so that the change of the storage volume of the reservoir obtained through the calculation under the principle of water balance is consistent with the change of the storage volume in the time periods corresponding to the two remote sensing images;
Step 5: Taking the final approximation result as the outflow coefficient of the ungauged reservoir, and calculating the outflow process of the water reservoir during floods.

2. The method according to claim 1, wherein the step 1 comprises:
Step 11: Extracting the water surface area of the ungauged reservoir at different contour lines by using the digital elevation model to obtain the water level-area relation curve of the water reservoir;
Step 12: Dividing the water reservoir into layers by elevation difference Δh, starting from the bottom of the water reservoir, according to the water level-area relation curve of the water reservoir, and calculating the storage volumes of the water reservoir at different water levels with the following formula:
$$\begin{matrix}V ( {h}_{l} ) = {\sum }_{j = 1}^{l} Δ V ( {h}_{j} ) \\ {h}_{j} = j \times Δ h \\ Δ V ( {h}_{j} ) = \frac{Δ h}{3} ( S ( {h}_{j - 1} ) + \sqrt{S ( {h}_{j - 1} ) \times S ( {h}_{j} )} + S ( {h}_{j} ) )\end{matrix}$$
where hₗ represents the water level of the l^{th} layer; V(hₗ) represents the total storage volume of the water reservoir corresponding to the water level hₗ; ΔV(hⱼ) represents the incremental storage volume from the j−1^{th} layer to the j^{th} layer; S(hⱼ₋₁) and S(hⱼ) represent the water surface areas of the water reservoir at the (j−1)^{th} layer and the j^{th} layer;
Step 13: Obtaining an area-storage volume relation curve of the water reservoir by using the storage volume data at different water levels obtained with the above formula and the water level-area relation curve in combination.

3. The method according to claim 2, wherein the elevation difference Δh is within 1.5 m.

4. The method according to claim 1, wherein the step 3 comprises:
Obtaining two remote sensing images at different times at a time interval ΔT after flood releasing of the reservoir is started, taking Δt starting from the first remote sensing image as a unit calculation period, calculating a cumulative sum of the storage volume in k unit calculation periods, calculating a cumulative sum to the initial storage volume of the water reservoir to obtain the corresponding storage volume of the water reservoir after a time period k×Δt:
$$\begin{matrix}{t}_{k} = {t}_{0} + k \times Δ t \\ V ( {t}_{k} ) = {V}_{0} + {\sum }_{i = 1}^{k} Δ V ( Δ {t}_{i} )\end{matrix}$$
where t₀ represents the time corresponding to the first remote sensing image, i.e., the initial time; V(tₖ) represents the corresponding storage volume of the water reservoir after the period k×Δt from the initial time; V₀ represents the corresponding storage volume of the water reservoir at the initial time, i.e., the initial storage volume; ΔV(Δtᵢ) represents the change of the storage volume of the water reservoir corresponding to the i^{th} unit calculation period; Δtᵢ represents the i^{th} unit calculation period;
Obtaining a storage volume sequence V(t₁), V(t₂), . . . , V(tₖ) of the water reservoir through the cumulative calculation in k×Δt time periods, and then obtaining a water level sequences H(t₁), H(t₂), . . . , H(tₖ) of the water reservoir by using the storage volume sequence and the water level-area-storage volume relation curves obtained in the step 2 in combination;
Carrying out cumulative calculation in time period ΔT when k=ΔT/Δt, to obtain the storage volume of the water reservoir corresponding to the second remote sensing image; here, the change of the storage volume of the water reservoir in the time period corresponding to the two remote sensing images is as follows:
$$\overline{Δ V} = {\sum }_{i = 1}^{k} Δ V ( Δ {t}_{i} )$$
where ΔV represents the change of the storage volume of the water reservoir in the time period ΔT corresponding to the two remote sensing images.

5. The method according to claim 4, wherein in the step 3, the corresponding change ΔV(Δtᵢ) of the storage volume of the water reservoir during the i^{th} segment of the time period ΔT is calculated with a water balance equation as follows:
ΔV(Δtᵢ)=Wᵢₙ(Δtᵢ)+Wₚ(Δtᵢ)−Wₒᵤₜ(Δtᵢ)
where Wᵢₙ(Δtᵢ) represents the total volume of inflow from the upstream of the water reservoir within Δtᵢ; Wₚ(Δtᵢ) represents the total volume of rainfall on the water surface area of the water reservoir within Δtᵢ; Wₒᵤₜ(Δtᵢ) represents the total volume of outflow through the spillway within Δtᵢ;
Wᵢₙ(Δtᵢ)=Qᵢₙ×Δtᵢ
Wₚ(Δtᵢ)=Qₚ×Δtᵢ
Wₒᵤₜ(Δtᵢ)=Qₒᵤₜ×Δtᵢ
where Qᵢₙ represents the flow of inflow from the upstream of the water reservoir within Δtᵢ; Qₚ represents the flow formed by rainfall on the water surface area of the water reservoir within Δtᵢ;
Qₒᵤₜ represents the flow discharged through the spillway of the water reservoir within Δtᵢ;
Wherein, the flow Qₒᵤₜ discharged through the spillway is calculated with a weir flow formula:
$${Q}_{out} = {λ}_{0} \times {( H ( {t}_{i} ) - {H}_{c} )}^{\frac{3}{2}}$$
where Qₒᵤₜ is the flow of discharge through the spillway at water level H(tᵢ), H_{c} is the crest elevation of the weir, and λ₀ is an outflow coefficient.

6. The method according to claim 5, wherein in the step 4, a function solved with the bisection method is as follows:
ƒ(λ)=ΔV*−Δ̅V̅(λ)
where ΔV* represents an ideal value of the change of the storage volume of the water reservoir corresponding to the two remote sensing images, which is obtained in the step 2;
The steps of solving an approximate value of the function ƒ(λ) at the zero point under a given accuracy with the bisection method are as follows:
Step 41: Determining an interval [a, b], verifying ƒ(a)×ƒ(b)<0, and specifying an accuracy ζ;
Step 42: Finding the midpoint c of the interval (a, b);
Step 43: Calculating ƒ(c):
(1) if ƒ(c)=0, then c is the zero point of the function,
(2) if ƒ(a)×ƒ(c)<0, then b=c,
(3) if ƒ(c)×ƒ(b)<0, then a=c,
(4) Determining whether the accuracy ζ is reached, i.e., if |a−b|<ζ, then an approximate value a or b at the zero point is obtained; otherwise the step 42 to the step 43 are repeated.
